(19) United States
(12) Patent Application Publication
(10) Pub. No.: US 2005/0238812 A1
(43) Pub. Date: Oct. 27, 2005

(54) Method for electroless metalisation of polymer substrate

(76) Inventors: Sunil Madhukar Bhangale, Singapore (SG); Peter Malcolm Moran, Singapore (SG)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/516,582

(22) PCT Filed: Jun. 3, 2003
(86) PCT No.: PCT/SG03/00136

§ 371 Date: Jun. 17, 2005

(30) Foreign Application Priority Data
Jun. 4, 2002 (SG) 0203314-0

(51) Int. Cl. B05D 3/04; B32B 15/08

(52) U.S. Cl. 427/304; 428/458

(57) ABSTRACT

A method of activating and metallising an aromatic polymer film including the steps of: treating a first surface of the film with a basic solution; applying to said first surface of the film an aqueous seeding solution comprising polymer-stabilised catalyst particles; and immersing the film in an electroless plating bath comprising ions of a desired metal so as to deposit a layer of said metal onto the first surface of said film.

### CROSS-REFERENCE TO RELATED APPLICATION

This U.S. national application filed under 35 U.S.C. § 371 claims priority to Singapore Application No. 200203314-0 filed Jun. 4, 2002.

### BACKGROUND OF THE INVENTION

1. Field of the Invention

This invention relates to an improved method for activating and metallising polymer substrates, in particular aromatic polymer substrates.

2. Description of Related Art

Substrates made of or containing aromatic polymers are often used in the construction of certain electronic assemblies, such as micro-electronic packaging. A large number of polymers have been found to be satisfactory for use as such substrates. Polyimides have been found to be particularly suitable in this regard, partly because of their excellent thermal stability and solvent resistance.

Aromatic polymers, such as polyimides, are extensively used in micro-electronic packaging applications such as flexible (Flex) circuits, rigid-flex circuits, printed circuit boards (PCB's), multi-layer flexible circuits and also as passivation layers on silicon chips. However, these aromatic polymers by themselves tend to have poor adhesion with metals (such as copper, nickel and gold) which are plated thereon. Accordingly, it has been necessary to develop certain techniques for improving the adhesion between such metals and these substrates. Several methods have been adopted in order to attempt to overcome this problem with poor adhesion.

For example, an adhesive is often used to bond the metal layers on these polymer films and, thereby, make metal-clad polymer films. Lithography is generally used to pattern the metal layer. However, with these clad films it is difficult to achieve fine line circuitry because etching of the metal layer leads to undercuts (due to etching underneath the mask) in the circuit lines and also the metal layer needs to be relatively thick (at least 15 microns) due to the fact that it needs to have mechanical strength for separate handling. Furthermore the adhesive used causes difficulties in laser drilling of micro-vias. Also it wastes metal.

Another means of attempting to improve adhesion has been by coating a liquid polyimide (or its precursor polyamic acid) onto a roughened metal foil (e.g. copper foil), followed by curing. However, fine line circuitry is once again difficult to achieve owing to the thickness of the metal foil.

Another known method for attempting to improve adhesion is the sputtering of a thin layer of chromium onto a polymer surface. A thin layer of copper is then sputtered onto the chromium layer. This copper layer is then thickened using electroplating. Although this method is able to produce fine line circuitry (by the use of a photoresist before the electroplating step) the sputtering steps are expensive and time consuming.

Also, in all of the above methods, the drilling of micro-vias through the metal coated polymer film is difficult. Also, after drilling, the micro-vias need to be plated separately.

Another technique to make metal-clad polymer films is electroless plating. However, the polymer surface needs to be activated (seeded) with a catalyst to initiate electroless plating. For instance, it has been found that palladium (Pd) is the most effective catalyst to initiate electroless plating.

The present invention is directed towards an improved method for activating a polymer substrate for electroless plating so as to achieve good adhesion between the substrate and a subsequently applied metal coating.

### BRIEF SUMMARY OF THE INVENTION

According to a first embodiment of this invention, there is provided a method of activating and metallising an aromatic polymer film including the steps of:
pre-treating a first surface of the film with a basic solution;
following the pre-treatment step, applying to said first surface an aqueous seeding solution comprising polymer-stabilised catalyst particles; and
then immersing the film in an electroless plating bath comprising ions of a desired metal so as to deposit a layer of said metal onto the first surface of said film.

Preferably the basic solution is a solution of sodium hydroxide (NaOH) or, more preferably, potassium hydroxide (KOH). A relatively wide range of concentrations is suitable for this solution (e.g. 0.2 to 2M). The basic solution may be applied by immersing the film in a bath of the basic solution. Alternatively, the basic solution may be applied by spraying a layer of the solution onto the first surface of the film. The surface (or surfaces) of the film which is (or are) to be activated should be maintained in contact with the basic solution for a certain period of time, depending upon the molarity and temperature of the basic solution (for example from 1 to 15 minutes for a 1 M KOH solution at room temperature). After immersion (or spraying), the basic solution is washed off, preferably with de-ionised water. Application of the basic solution is typically conducted at temperatures of between 20° to 60° Celsius.

In some cases, after treating the polymer film with the basic solution (e.g. KOH), the polymer film is subsequently treated with an acidic solution for protonation of the carboxylate ions formed on the surface. It is done by immersing the KOH treated film in an aqueous acid solution for a certain period of time (e.g. 2 to 20 minutes). Later on it is washed with de-ionised water and is dried, usually with flowing air.

It is preferred that the aqueous seeding solution contains polymer-stabilised palladium particles. This stabilisation may be effected by a water-soluble polymer, such as polyvinyl pyrrolidone (PVP) or polyvinyl alcohol (PVA), although PVP is particularly preferred.

Typically the abovementioned palladium particles will have diameters of from 1 to 50 nm, or more preferably, from 2 to 10 nm.

The aqueous seeding solution is typically applied to the film by immersing the film in a bath of the seeding solution. This immersing typically occurs for between 2 and 60 seconds. After this, the film is removed from the bath and excess seeding solution is removed, preferably by washing with de-ionised water.

The desired metals are typically selected from the group consisting of nickel, copper and gold. Therefore, the electroless plating bath will contain ions of the particular desired metal.

After the layer of the desired metal has been deposited onto the film, the film is preferably washed with de-ionised water and then dried.

After deposition of the metal layer, or after the subsequent washing and drying, the film may be heated to further improve adhesion between the film and the metal layer.

The above method can be applied to either the first surface of the film, a second surface of the film, or both surfaces.

It is particularly preferred that the aromatic polymer film is formed of polyimide (such as a Kapton™ film).

It has been found that forming micro-vias through (or substantially through) the film, prior to applying the basic solution is particularly preferred. These micro-vias can be drilled through or into the film using the known methods of laser drilling, mechanical drilling or by chemical etching. The film may then be subjected to the treatments with the basic solution and the seeding solution (as described above). During these treatments, the sidewalls of the micro-vias are activated simultaneously with the surface of the film. During the seeding step, the polymer stabilised catalyst particles are adsorbed onto the surface of the film as well as onto the sidewalls of the micro-vias. Similarly, during the metallisation step, the desired metal is coated onto the surface of the film as well as onto the sidewalls of the micro-vias. Accordingly, this method eliminates a step in the present methods in which micro-vias are typically drilled after patterning the circuitry and need to be plated separately from the rest of the circuitry.

Formation of the micro-vias in the polymer film prior to chemical treatment of the film is particularly advantageous. For instance, when both surfaces of the polymer film have subsequently been coated with the desired metal, the micro-vias will also be coated with the desired metal, thereby connecting the metal plated layers on the opposite surfaces of the polymer film.

In a preferred aspect of the invention, prior to treating the film with the basic solution, the film may be coated with a photoresist. The desired circuitry can then be defined by using a mask on the photoresist. The photoresist may then be developed so as to expose portions of the surface of the film corresponding with the desired circuitry patterns. The exposed film surface can then be treated and metallised as described above thereby enabling selective metallisation resulting in the formation of desired circuitry patterns on the film. Accordingly, with the assistance of a photoresist and subsequent masking, desired circuitry can be placed on the polymer film by selective metal plating.

### BRIEF DESCRIPTION OF THE DRAWINGS

A preferred embodiment of the invention will now be described with reference to the accompanying drawings in which:

FIG. 1 is a schematic illustration of a method of activating and metallising the two opposite surfaces of an aromatic polymer film according to a preferred embodiment of this invention.

FIG. 2 is an enlarged portion of a photograph showing a polyimide film on which a series of nickel pads have been formed according to the method of this invention.

FIG. 3 is a further enlarged photograph of a portion of the coated polyimide film shown in FIG. 2.

### DETAILED DESCRIPTION OF THE ILLUSTRATED EMBODIMENTS

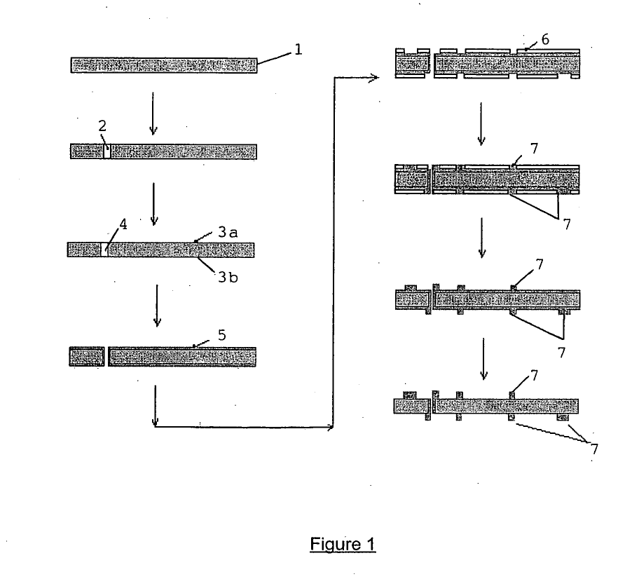

FIG. 1 schematically shows the formation of a double-sided Flex circuit manufactured in accordance with a preferred embodiment of this invention.

As shown, a film of clean Kapton™ 1 has a micro-via 2 formed there-through. The two opposed surfaces 3a, 3b of the film 1 is then subjected to chemical treatment with a strong basic solution, (such as KOH), followed by activation with the colloidal suspension of polymer-stabilised palladium particles. The sidewall (or sidewalls) 4 of the film 1 are simultaneously chemically treated and activated.

The activated film is then placed in an electroless metal plating bath (such as a electroless copper bath) causing a layer of metallic copper 5 to be formed on the surfaces 3a, 3b of the film and on the side walls 4 of the micro-via 2.

The plated film can then be treated so as to apply circuitry patterning. To achieve this, a photoresist 6 is applied having the desired patterning. Alternatively, a non-patterned strip of photoresist material may be applied to the surfaces and this strip then undergoes development (e.g. by use of a mask and etching steps so as to cause the desired patterning of the photoresist).

The plated film may then undergo electrolytic plating so as to cause metallic circuitry 7 to be formed on the copper layer 5.

The photoresist 6 may then be removed, for instance by known etching processes.

The layered film may then undergo further etching so as to remove the layer of electrolessly plated copper between the circuitry 7.

In accordance with the above invention, polymer films can be plated with the desired metal in regular patterned forms by using a micro-dispensing machine without using any photoresist mask. In this embodiment, an aqueous solution of potassium hydroxide is dispensed in the form of small droplets onto a clean polymer film. After about 5 to 10 minutes, the polymer film is washed with de-ionised water followed by drying with compressed air.

The film is then treated with the seeding solution after which it is washed with de-ionised water and dried. This causes the film to be selectively seeded where the potassium hydroxide solution had been dispensed.

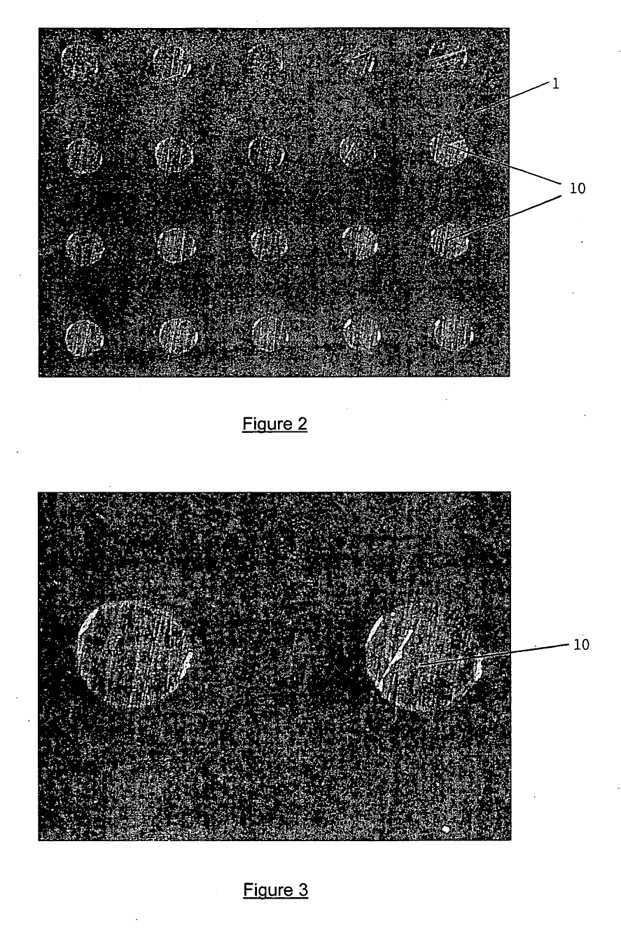

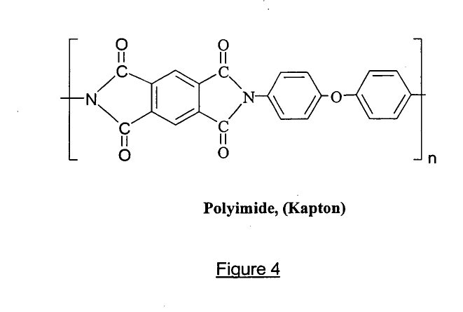

The film is then subjected to electroless plating for a period of time sufficient to cause a desired amount of the metal to be deposited on the film. This causes the metal to be plated selectively only on the activated regions of the film. As shown in FIGS. 2 and 3, this ease of patterning metal, in the form of fine circles 10 on a polymer film, can be used in the formation of metal pads in ball grid array (BGA) packages.

The present invention can also be applied in the redistribution of connecting pads on a silicon wafer. Aromatic polymer films are widely used as passivation layers on silicon chips. By using the present invention, the connecting pads on the circumference of the chip can be redistributed on its surface.

Accordingly, this invention provides an alternative method for electrolessly coating a surface of an aromatic polymer film with a desired metal. The method of this invention also enables circuitry with desired micro-vias to be manufactured more simply and conveniently than has previously been the case.

### EXAMPLE

(i) For demonstration purpose, 5 mil thick Kapton®, which is a commercial polyimide made from pyromellitic dianhydride (PMDA) and 4-4′ diamino-diphenyl ether (or oxy-di-aniline, ODA) represented by a general formula as shown in FIG. 4 was used. It was treated with a 1 M aqueous potassium hydroxide (KOH) solution for 10 minutes at room temperature. The KOH attacks the imide group in polyimide forming potassium salt of polyamic acid. The film was washed thoroughly with de-ionised (DI) water to remove excess of KOH and then was dried using a compressed air flow. This alkali treated Kapton film was then kept in contact with 0.2M hydrochloric acid (HCl) solution for 10 minutes at room temperature and subsequently was washed with DI water and was dried. This chemical treatment formed polyamic acid on Kapton surface, introducing the carboxylic acid groups.

An example of how to prepare an aqueous suspension of palladium particles stabilised by polyvinyl pyrrolidone (PVP) is as follows:
Dissolve 150 mg of PVP (weight averaged molecular weight=50,000, although it could be anywhere from 10,000 to about 500,000) in DI water.
Dissolve 150 mg of PdCl₂ in 5.25 ml of HCl (−37% pure).
Mix the PVP and Pd Cl₂ solutions together.
Slowly add 10 ml-35 ml of hypophosphorous acid (H₃O₂P), 50% pure, to the solution.
Add DI water until the total volume of the solution is 1 litre.

The chemically treated Kapton film was then immersed in an aqueous suspension of the polyvinyl pyrrolidone (PVP) coated palladium particles for 30 seconds, followed by washing with DI water and drying.

This Pd catalyst activated Kapton film was then subjected to electroless copper plating at 25° C. for 15-60 minutes. A thin layer (1-2 μm) of copper was plated on Kapton.

(ii) The procedure of example (i) was followed except that electroless nickel plating bath was used to plate a thin layer (1-2 μm) of nickel at 80° C. for about 15-30 minutes.

It will be readily apparent to a skilled addressee that many variations and modifications to the present invention will be possible without departing from the spirit and scope thereof.

In this specification, except where the context requires otherwise, the words “comprise”, “comprises” or “comprising” mean “include”, “includes” or “including”, respectively. That is, when the invention is described or defined as comprising certain features or components, it is to be understood that the invention includes (at least) these features or components but may also (unless the context indicates otherwise) include other features or components.

1. A method of activating and metallising an aromatic polymer film including the steps of:
pre-treating a first surface of an aromatic polymer film with a basic solution;
following the pre-treatment step, applying to said first surface of the film an aqueous seeding solution comprising polymer-stabilized catalyst particles; and
then immersing the film in an electroless plating bath comprising ions of a desired metal so as to deposit a layer of said metal onto the first surface of said film.

2. The method of claim 1, wherein the basic solution is a solution of potassium hydroxide.

3. The method of claim 1, wherein after the basic solution treatment step, an acidic solution is applied to said first surface.

4. The method of claim 3 wherein the acidic solution is a solution of protic acid such as hydrochloric acid (HCl) or acetic acid.

5. The method of claim 1, wherein the aqueous seeding solution comprises polymer-stabilised palladium particles.

6. The method of claim 1, wherein the catalyst particles are stabilised by a water-soluble polymer.

7. The method of claim 6, wherein the water-soluble polymer is polyvinyl pyrrolidone (PVP) or polyvinyl alcohol (PVA).

8. The method of claim 7, wherein the water-soluble polymer is PVP.

9. The method of claim 5, wherein the palladium particles have diameters of from 1 to 50 nanometers.

10. The method of claim 1, wherein the desired metal is selected from the group consisting of nickel, copper and gold.

11. (canceled)

12. The method of claim 1, wherein the basic solution is applied by immersing the film in a bath of the basic solution.

13. The method of claim 1, wherein the basic solution is applied by spraying a layer of the solution onto the first surface of said film.

14. The method of claim 1, wherein the film is maintained in contact with the basic solution for 1 to 15 minutes after which the basic solution is washed off.

15. The method of claim 1, wherein the aqueous seeding solution is applied by immersing the film in a bath of the seeding solution.

16. The method of claim 15, wherein said immersion is for a period of from 5 to 60 seconds.

17. The method of claim 1, wherein, after application of the aqueous seeding solution, the film is washed with de-ionised water to remove excess catalyst particles.

18. The method of claim 1, wherein after the depositing of the layer of the desired metal, the film is washed with de-ionised water and dried.

19. The method of claim 1, wherein after the depositing of the layer of the desired metal, the film is heated to improve adhesion between the film and the metal layer.

20. The method of claim 1, wherein prior to the step of applying the basic solution, vias are formed, either substantially or entirely, through the film.

21. The method of claim 20, wherein the vias are formed using laser drilling techniques.

22. The method of claim 1, wherein prior to the step of applying the basic solution, photoresist material is applied to the film and said photoresist material is developed so as to facilitate patterning of desired circuitry onto said film.

23. The method of claim 1 wherein, prior to the step of applying the basic solution, the film is cleaned and dried.

24. The method of claim 23, wherein the cleaning is effected by ultrasonication in acetone and de-ionised water.

25. The method of claim 24, wherein further cleaning is effected by ozone treatment at elevated temperature.

26. The method of claim 25, wherein the ozone treatment is conducted at about 80° C. for between 3 and 10 minutes.

27. The method of claim 1, wherein the aromatic polymer film is formed of polyimide.

28. (canceled)

29. A metal coated aromatic polymer film made according to the method of
pre-treating a first surface of an aromatic polymer film with a basic solution:
following the pre-treatment step, applying to said first surface of the film an aqueous seeding solution comprising polymer-stabilized catalyst particles; and
then immersing the film in an electroless plating bath comprising ions of a desired metal so as to deposit a layer of said metal onto the first surface of said film.
